(19) United States
(12) Patent Application Publication
(10) Pub. No.: US 2022/0185065 A1
(43) Pub. Date: Jun. 16, 2022

(54) METHOD FOR OPERATING A HEAT PUMP OF AN ELECTRIC MOTOR VEHICLE

(71) Applicant: VOLKSWAGEN AG, Wolfsburg (DE)

(72) Inventors: Jan-Christoph ALBRECHT, Wolfsburg (DE); Jochen WESTHÄUSER, Braunschweig (DE); Carsten WACHSMUTH, Schwülper (DE)

(73) Assignee: VOLKSWAGEN AKTIENGESELLSCHAFT, Wolfsburg (DE)

(21) Appl. No.: 17/415,727

(22) PCT Filed: Dec. 16, 2019
(86) PCT No.: PCT/EP2019/085286

§ 371 Date: Mar. 2, 2022

(30) Foreign Application Priority Data
Dec. 21, 2018 (DE) 10 2018 133 447.8

(51) Int. Cl. B60H 1/00; B60H 1/14; B60H 1/22

(52) U.S. Cl. CPC B60H 1/00814; B60H 1/00392; B60H 1/143; B60H 2001/3241; B60H 1/2218; B60H 2001/00961; B60H 1/00828

(57) ABSTRACT

The invention relates to a method for defrosting an external-air heat exchanger of an electric vehicle. Contrary to the conventional principle of operating systems in an electric vehicle at the lowest possible output power, according to the invention, high output power is used for the defrosting process, to reduce the defrosting time and thus reduce heat loss.

The invention relates to a method for operating a heat pump of an electric motor vehicle according to the preamble of patent claim 1.

Heat exchangers are used in a variety of ways in motor vehicles, for example, for air conditioning the motor vehicle. In this function, it is known to provide heat exchangers as part of a heat pump, with which heat is obtained from the outside air for air conditioning the motor vehicle.

However, the problem with such heat pumps is that the heat exchanger tends to ice up at low outside temperatures, since it has to be very cold, in particular colder than the surroundings, in order to achieve a temperature difference necessary for the heat transfer. As a result, defrosting becomes necessary, which in turn can be very energy-intensive. Defrosting becomes all the more energy-intensive if outside air still reaches the heat exchanger during defrosting and the heat energy provided for defrosting is absorbed by the outside air. This is a problem with regard to the range, especially in electric vehicles.

A method for controlling a de-icing device on a motor vehicle is known, for example, from DE 10 2012 207 925 A1. Here, a planned start of use of the motor vehicle is recorded, meteorological information is recorded at the location of the motor vehicle, the need for de-icing is determined and de-icing is initiated in such a way that de-icing is complete by the planned start of use.

DE 10 2014 102 078 A1 describes a further method for defrosting a heat exchanger of an air conditioning system of a motor vehicle by switching from a heat pump mode to a defrosting mode. In the method, defrosting takes place when the motor vehicle is stationary or is traveling at low speeds.

The object underlying the invention is now to provide a technical solution with which efficient and effective defrosting of the heat exchanger after icing is possible in an electric motor vehicle.

The object is solved by the subject matter of independent patent claim 1. Further preferred embodiments of the invention result from the other features cited in the dependent claims.

A first aspect of the invention relates to a method for operating a heat pump of an electric motor vehicle, in which the operated heat pump comprises an external-air heat exchanger and in which the heat pump is operated at least temporarily in an operating mode in which ice or frost forms on the external-air heat exchanger and the external-air heat exchanger is then defrosted.

According to the invention, it is provided that the defrosting takes place with a heat output power of at least 1 kW.

The heat output power is preferably at least 3 kW, more preferably at least 5 kW.

Contrary to the conventionally followed principle of operating systems in an electric motor vehicle with the lowest possible output power, tests by the applicants have shown that the high output power levels for defrosting according to the invention may reduce the defrosting time in such a way that the greatest possible overall efficiency is nevertheless achieved. A positive effect here is that due to the very rapid defrosting, the amount of outside air that flows around the external-air heat exchanger while driving, and thus the heat loss, is significantly reduced.

In one preferred embodiment of the method of the invention, it is provided that, in order to defrost the outside air heat exchanger, the heat pump is operated in an operating mode in which heat is drawn from a battery or from another traction component of the motor vehicle.

By removing the heat from the battery, preferably by evaporating a refrigerant in the battery or in a secondary water circuit, for example, connecting the battery or traction components via a heat exchanger, the performance may be significantly increased compared to other heat sources. The main advantage here is the generally higher temperature level of the battery compared to, for example, the ambient air. The thermal mass of the battery or the electric motor is also large, so that the high output power may be drawn over a longer period of time without the components cooling down significantly. A high temperature level at which the heat may be drawn is advantageous for the available output power due to an increased suction pressure.

In one further preferred embodiment of the method of the invention, it is provided that at least an output power drawn by the heat pump is compensated for via an electric heating element in a cooling system of a traction component of the motor vehicle, thus avoiding a cooling of the traction component.

Thus, since the heat is supplied by an electric heater, the heat may be drawn without affecting the traction components.

In one alternative preferred embodiment of the method of the invention, it is provided that, in order to defrost the external-air heat exchanger, the heat pump is operated in an operating mode in which hot gas is introduced from a compressor of the heat pump into the external-air heat exchanger, wherein between the heat emission in the external-air heat exchanger and the renewed compression a maximal mass fraction of 30% undergoes evaporation after throttling.

This alternative variant does not require an additional heat source, since only the electrical output power consumed by the compressor is used. This method is useful when, for example, the traction components are not intended to be further cooled for reasons of performance or service life.

In one alternative preferred embodiment of the method of the invention, it is provided that, to defrost the external-air heat exchanger, the heat pump is operated in an operating mode in which heat is drawn from an evaporator of an air conditioning unit of the motor vehicle.

Here, the air flowing into the cabin of the motor vehicle serves as a heat source. This is advantageous in that no heat is required to be drawn from the traction components, i.e., they are not cooled. Compared to the variant described above, this method is more efficient, since not only the electrical output power of the compressor is available for defrosting, but also the amount of heat drawn from the air.

In one further preferred embodiment of the method of the invention, it is provided that for defrosting, an air mass flow through the external-air heat exchanger is reduced.

The energy loss resulting from some of the heat supplied being given off to the outside air flow may be even further reduced. The heating is therefore primarily used to melt the ice, which makes defrosting even more efficient. The positive effect of the high output power at the heat exchanger during defrosting, as described at the outset, is thus intensified.

In one further preferred embodiment of the method of the invention, it is provided that the air mass flow occurs as a result of closing a shut-off device upstream from the external-air heat exchanger.

The shut-off device may include a radiator shutter, for example. The air mass flow may thus even be completely shut off, so that the positive effect described above is significantly increased.

In one further preferred embodiment of the method of the invention, it is provided that the air mass flow as a result of at least partially compensating for an air pressure difference upstream and downstream from the external-air heat exchanger using a fan.

For example, a direction of rotation of a radiator fan of the motor vehicle may be reversed and promote air against the direction of travel. The incoming flow of outside air may thus be counteracted. This is particularly advantageous when, for example, there is no radiator shutter.

In one further preferred embodiment of the method of the invention, it is provided that the method is carried out when an air pressure difference upstream and downstream from the external-air heat exchanger is at a minimum over a period of at least 30 minutes.

In this way, defrosting with high output power is facilitated since a driving situation is determined that is favorable for avoiding heat loss.

The air pressure difference upstream and downstream from the outdoor air heat exchanger is primarily influenced by the driving speed. The period of time may thus be estimated, for example, on the basis of navigation data, i.e., it may be predicted when the driving speed, and thus also the air pressure difference, is minimal.

In one further preferred embodiment of the method of the invention, it is provided that the air pressure difference is predicted by means of an estimate based on a driving profile using data from a navigation system.

In this way, defrosting with high output power is facilitated, since a driving situation favorable for avoiding heat loss is determined in advance and defrosting may be particularly well planned.

For example, knowing that a planned route through a city follows a trip on the freeway may be used to predict that the driving speed in the city will be reduced compared to an average speed on the freeway.

Resummarized in other words, the invention relates to a method for defrosting an external-air heat exchanger of an electric vehicle. Contrary to the conventional principle of operating systems in an electric motor vehicle at the lowest possible output power, it is provided that high output power is used for the defrosting process, to reduce the defrosting time and thus reduce the heat loss.

Unless otherwise stated for an individual case, the various embodiments of the invention cited in this application may be advantageously combined with one another.

1. A method for operating a heat pump of an electric motor vehicle, in which the operated heat pump comprises an external-air heat exchanger, comprising:
operating the heat pump at least temporarily in an operating mode in which ice forms on the external-air heat exchanger, and
defrosting the external-air heat exchanger, wherein the defrosting takes place with a heat output power of at least 1 kW.

2. The method according to claim 1, wherein the heat pump is operated in an operating mode in which heat is drawn from a battery or from another traction component of the motor vehicle.

3. The method according to claim 1, wherein the heat pump is operated in an operating mode in which hot gas is introduced from a compressor of the heat pump into the external-air heat exchanger and between the heat emission in the external-air heat exchanger and the renewed compression, a maximum mass fraction of 30% undergoes vaporization after throttling.

4. The method according to claim 1, wherein the heat pump is operated in an operating mode in which heat is removed from an evaporator of an air conditioning unit in the motor vehicle.

5. The method according to claim 2, wherein at least an output power drawn by the heat pump is compensated for by an electric heating element in a cooling system of a traction component of the motor vehicle, thus avoiding a cooling of the traction component.

6. The method according to claim 1, wherein for defrosting, an air mass flow through the external-air heat exchanger is reduced.

7. The method according to claim 6, wherein the air mass flow occurs as a result of closing a shut-off device upstream from the external-air heat exchanger.

8. The method according to claim 6, wherein the air mass flow occurs as a result of at least partially compensating for an air pressure difference upstream and downstream from the external-air heat exchanger using a fan.

9. The method according to claim 1, wherein an air pressure difference upstream and downstream from the external-air heat exchanger is at a minimum over a period of at least 30 minutes.

10. The method according to claim 9, wherein the air pressure difference is predicted by means of an estimate based on a driving profile using data from a navigation system.
